(19) United States
(12) Patent Application Publication
(10) Pub. No.: US 2026/0278982 A1
(43) Pub. Date: Sep. 17, 2026

(54) TEST POSITIONING METHOD, DEVICE, STORAGE MEDIUM, AND TARGET IMAGE

(71) Applicant: Hue Inc., Shanghai (CN)

(72) Inventors: Kuoyuan SUN, Shanghai (CN); Xingtong JIANG, Shanghai (CN); Jinxu WANG, Shanghai (CN)

(73) Assignee: Hue Inc., Shanghai (CN)

(21) Appl. No.: 19/568,804

(22) Filed: Mar. 17, 2026

(30) Foreign Application Priority Data
Mar. 17, 2025 (CN) 202510310897.6

(51) Int. Cl. G06V 10/24; G06T 5/80; G06V 10/60

(52) U.S. Cl. CPC G06V 10/245; G06T 5/80; G06V 10/60

(57) ABSTRACT

The present disclosure provides a test positioning method for a display. A target image with a plurality of first positioning points and a plurality of second positioning points having different shapes and/or dimensions, with second points at predetermined positions is displayed and captured. The second positioning points in the first captured image are determined by a homography matrix based on their predetermined and actual positions. The positioning points are transformed using the matrix to obtain a mapping point set, thereby improving test positioning accuracy and user experience. The present disclosure also provides a test positioning device for a display.

### CROSS-REFERENCE TO RELATED APPLICATION

This application claims the priority benefit of China application serial no. 202510310897.6, filed on Mar. 17, 2025. The entirety of the above-mentioned patent application is hereby incorporated by reference herein and made a part of this specification.

### TECHNICAL FIELD

The present disclosure generally relates to the field of display technology, and more specifically relates to a test positioning method, a device, a storage medium, and a method for providing a target image.

### BACKGROUND

In the current era of flourishing advancements in display technology, optical waveguide modules as core components of near-eye displays such as augmented reality (AR) and virtual reality (VR), etc., have become increasingly pivotal. Serving as the “visual center” of these devices, the optical waveguide modules shoulder the critical task of efficiently guiding image light rays into the user's field of view, which significantly determines the display experience of AR/VR devices.

However, there is a significant shortcoming in the currently widely used diffractive optical waveguide modules. Within the eyebox (i.e., the visible area of the human eye), their uniformity of brightness and chromaticity are poor, and the emergence of this issue seriously undermines the immersive visual experience brought by AR/VR devices to users and urgently needs to be solved.

Currently, the issue of brightness and color uniformity of the display is generally solved through test positioning technology of the display. The test positioning of the display refers to the process of positioning each pixel of the display after manufacturing and before leaving the factory to test the brightness and chromaticity of the pixel, and then correcting its brightness and chromaticity. The test positioning of a display is crucial for quality control of the display. For example, through precise test positioning, it can ensure that the test instruments accurately collect various performance data at specific positions on the display, for example, when detecting pixel brightness and color, it can ensure that the measured values are the true values of the specified pixel points, avoiding data inaccuracies caused by positional deviations and providing reliable foundations for subsequent analysis and judgment. Furthermore, accurate test positioning can comprehensively and meticulously detect the performance indicators of various positions of the display, timely discover potential problems such as bad pixels, bright spots, color unevenness, display abnormalities, etc., which helps to take actions timely for repair or adjustment during the production process and improve the yield rate of products. Furthermore, displays after precise test positioning and correction can ensure stable, clear, and color accurate of display effects in all areas during user use, avoiding display defects or abnormalities and providing users with a good visual experience.

The display test positioning technologies include various methods such as physical identification positioning, coordinate positioning, image recognition positioning, and laser positioning, etc. In these methods, image recognition positioning can accurately analyze the feature points and boundaries of specific patterns on the display, thereby achieving high-precision positioning. For example, during pixel-level testing, it is possible to accurately locate the position of each pixel point, accurately detect the performance of the pixel, and accurately position small issues such as bad pixels and bright spots, providing a reliable basis for the quality inspection of the display. Furthermore, image recognition positioning method also has many advantages, such as non-contact detection, adaptability to complex shapes and diverse tests, obvious advantages in automation tests, rich and traceable data, etc., therefore, it is increasingly applied in the testing of high-end displays such as near-eye displays.

However, due to the shortcomings in existing display technologies, defects such as non-illuminated pixels, low brightness, and uneven brightness frequently occur in specific screen areas (e.g., at the four corners), which pose difficulties for accurate image recognition and positioning of the display.

### SUMMARY OF THE DISCLOSURE

Starting from the prior art, the task of the present disclosure is to provide a test positioning method, a device, a storage medium, and a method for providing a target image, through this method or device, the test positioning accuracy of the display can be significantly improved. In a first aspect of the present disclosure, the aforementioned task is solved by a test positioning method for a display, the method includes:

displaying a target image on the display, and the target image includes a plurality of first positioning points and a plurality of second positioning points, and the shapes and/or dimensions of the second positioning points are different from those of the first positioning points, and the second positioning points are located at predetermined positions of the target image;

capturing the displayed target image to obtain a first captured image;
identifying the second positioning points in the first captured image;

determining a homography transformation matrix between the target image and the first captured image according to the predetermined positions of the second positioning points in the target image and actual positions of the second positioning points in the first captured image; and identifying the first positioning points in the first captured image, and transforming the first positioning points and the second positioning points through the homography transformation matrix to obtain a mapping point set between the target image and the first captured image.

In one embodiment of the present disclosure, the method further includes:
displaying a test image on the display;
capturing the displayed test image to obtain a second captured image; and
obtaining brightness information and/or chromaticity information of the test image according to the second captured image through the mapping point set.

In another embodiment of the present disclosure, the target image is a rectangle, and the predetermined positions include four corners of the rectangle, and each corner includes a square area with a side length of 1% to 30% of the side length of the rectangle.

In another embodiment of the present disclosure, the shapes of the second positioning points are different from the shapes of the first positioning points, the shapes of first positioning points are circles, and the shapes of the second positioning points are selected from triangles, squares, rectangles, ellipses, or n-sided polygons, and n≥5.

In another embodiment of the present disclosure, the dimensions of the second positioning points are different from the dimensions of the first positioning points, and the dimensions of the second positioning points are 1.5 to 5 times the dimensions of the first positioning points.

In another embodiment of the present disclosure, the dimensions include: area, diameter, radius, side length, maximum transversal dimension, or maximum longitudinal dimension.

In another embodiment of the present disclosure, the plurality of second positioning points include at least four second positioning points.

In another embodiment of the present disclosure, after determining the homography transformation matrix, the method further includes:
correcting the first captured image to suppress distortion and/or rotation in the first captured image.

In another embodiment of the present disclosure, correcting the first captured image to suppress distortion and/or rotation in the first captured image includes the following steps:
capturing a distortion correction image without distortion;
identifying the second positioning points without distortion in the distortion correction image;
identifying the second positioning points with distortion in the first captured image;
determining distortion correction coefficients according to pixel coordinates of the second positioning points without distortion and the second positioning points with distortion;
correcting the first captured image using the distortion correction coefficients; and
displaying the corrected first captured image on the display.

In another embodiment of the present disclosure, the method further includes:
sorting the mapping point set according to a sorting rule based on the coordinates of the mapping point set; and
interpolating and supplementing the sorted mapping point set to supplement missing pixels in the first captured image to the mapping point set, and the missing pixels are pixels that are bright on the target image but not bright on the first captured image.

In another embodiment of the present disclosure, the method further includes:
sorting the mapping point set according to a sorting rule based on the coordinates of the mapping point set; and
interpolating and supplementing the sorted mapping point set to supplement empty pixels to the mapping point set, and the empty pixels are pixels that should be bright but are not bright on the target image.

In another embodiment of the present disclosure, the sorting rule includes at least one of the following:
sorting based on Z-shape, sorting based on coordinate mapping, or sorting based on feature matching.

In another embodiment of the present disclosure, the dimensions of the first positioning points are different from the dimensions of the second positioning points, and the dimensions of the first positioning points are less than a first threshold and the dimensions of the second positioning points are greater than a second threshold, wherein:
identifying the first positioning points in the first captured image includes:
   extracting the first graphic with a dimension less than the first threshold from the target image through image recognition; and
   identifying the first graphic with a dimension less than the first threshold as the first positioning points; and
identifying the second positioning points in the first captured image includes:
   extracting a second graphic with a dimension greater than the second threshold from the target image through image recognition; and
   identifying the second graphic as the second positioning points.

In another embodiment of the present disclosure, the first positioning points have a first shape and the second positioning points have a second shape, and the first shape is different from the second shape, wherein:
identifying the first positioning points in the first captured image includes:
   extracting a first graphic having the first shape in the target image through image recognition; and
   identifying the first graphic as the first positioning points; and
identifying the second positioning points in the first captured image includes:
   extracting a second graphic having the second shape in the target image through image recognition;
   identifying the second graphic as the second positioning points; and
   determining whether the number of second positioning points equals N.

In another embodiment of the present disclosure, the number of second positioning points is N, and N is a natural number, and identifying the second positioning points in the first captured image further includes:
determining whether the number of second positioning points equals N; and
if so, ending the identification; otherwise, the identification fails.

In another embodiment of the present disclosure, the method further includes:
fitting the centers of the second positioning points in the first captured image; and
using the centers as key control points to determine the homography transformation matrix.

In a second aspect of the present disclosure, the aforementioned task is solved by a test positioning device for a display, the device includes:
a camera configured to capture a displayed target image to obtain a first captured image, and capture a test image displayed on the display to obtain a second captured image; and
a controller configured to perform:
   transmitting image signals to the display to display a target image on the display, and the target image includes a plurality of first positioning points and a plurality of second positioning points, and the shapes and/or dimensions of the second positioning points are different from those of the first positioning points, and the second positioning points are located at predetermined positions of the target image;
   identifying the second positioning points in the first captured image;
   determining a homography transformation matrix between the target image and the first captured image according to the predetermined positions of the second positioning points in the target image and the actual positions of the second positioning points in the first captured image; and
   identifying the second positioning points in the first captured image, and transforming the first positioning points and the second positioning points through the homography transformation matrix to obtain a mapping point set between the target image and the first captured image; and
   obtaining brightness information and/or chromaticity information of the test image according to the second captured image through the mapping point set.

In one embodiment of the present disclosure, the display includes one or more of the following items: an optical waveguide, a computer display, a near-eye display, a virtual reality VR display, an augmented reality AR display, a smartwatch display, and a smartphone display.

In one embodiment of the present disclosure, the display is a micro-LED display.

In another embodiment of the present invention, the micro-LED display includes a micro-LED chip, and the micro-LED chip includes:
a light-emitting mesa;
an insulating layer accommodating the light-emitting mesa and through-hole contact portions;
a drive circuit provided with a metal layer on its surface, the drive circuit is provided with a plurality of through-hole contact portions, the through-hole contact portions are electrically connected with the metal layer, and the micro-LED array area is bonded onto the drive circuit through a bottom conductive bonding layer, and the drive circuit further has a wiring stack below the metal layer, which leads out a first electrode;
a first electrode electrically connected with the through-hole contact portions;
a passivation layer covering at least a part of a side surface of the light-emitting mesa;
a top transparent conductive layer located on a surface of the passivation layer and in electrical contact with the second epitaxial layer; and
a second electrode located on a surface of the transparent conductive layer.

In another embodiment of the present disclosure, the target image further includes an autofocus graphic for autofocusing between the camera and the display.

In one embodiment of the present disclosure, the autofocus graphic includes a transversal line group, a longitudinal line group, an oblique line group, and a combination of the above lines.

Furthermore, the present disclosure also provides a computer-readable storage medium storing a computer program thereon, and the computer program performs the following steps when executed by a processor:
sending signals to a display to display a target image, and the target image includes a plurality of first positioning points and a plurality of second positioning points, and the shapes and/or dimensions of the second positioning points are different from those of the first positioning points, and the second positioning points are located at predetermined positions of the target image;
sending signals to a camera to capture the displayed target image to obtain a first captured image;
identifying the second positioning points in the first captured image;
determining a homography transformation matrix between the target image and the captured image according to the predetermined positions of the second positioning points in the target image and the actual positions of the second positioning points in the first captured image; and
identifying the first positioning points in the first captured image, and transforming the first positioning points and the second positioning points through the homography transformation matrix to obtain a mapping point set between the target image and the first captured image.

Furthermore, the present disclosure provides a test positioning method for a display, which includes the steps of:
sending signals to a display to display a target image, and the target image includes a plurality of first positioning points and a plurality of second positioning points, and the shapes and/or dimensions of the second positioning points are different from those of the first positioning points, and the second positioning points are located at predetermined positions of the target image;
sending signals to a camera to capture the displayed target image to obtain a first captured image;
identifying the second positioning points in the first captured image;
determining a homography transformation matrix between the target image and the captured image according to the predetermined positions of the second positioning points in the target image and the actual positions of the second positioning points in the first captured image; and
identifying the first positioning points in the first captured image, and transforming the first positioning points and the second positioning points through the homography transformation matrix to obtain a mapping point set between the target image and the first captured image.

Furthermore, the present disclosure provides a method for providing a target image, which includes:
generating image signals for displaying a target image, and the target image includes a plurality of first positioning points and a plurality of second positioning points, and the shapes and/or dimensions of the second positioning points are different from those of the first positioning points, and the second positioning points are located at predetermined positions of the target image; and
displaying the image signal.

Furthermore, the present disclosure provides a target image, including a plurality of first positioning points and a plurality of second positioning points, and the shapes and/or dimensions of the second positioning points are different from the shapes and/or dimensions of the first positioning points, and the second positioning points are located at predetermined positions of the target image.

The present disclosure has at least the following technical effects: through research, the inventors discovered that existing image test positioning methods all use small circular dots of the same size to locate corresponding pixels. However, if small circular dots are all used for capturing, due to the pixel non-uniformity of special displays such as waveguide modules, etc., coordinates of small circular dots in specific areas (particularly in the four corners) are difficult to be extracted; instead, in the present disclosure, second positioning points with different sizes or shapes from the first positioning points are used to locate pixels in special areas such as corners, etc., so that even if a pixel in one of the four corners is a dead point, and cannot be turned on, or has poor uniformity, due to the large area or significantly different shapes of bright areas, the pixels in these areas can still be accurately located. This approach significantly improves the robustness of the positioning algorithm in special areas (particularly the four corners).

### BRIEF DESCRIPTION OF THE DRAWINGS

The present disclosure is further explained with reference to the accompanying drawings in conjunction with specific implementations below.

FIG. 1 shows a first embodiment of a target image according to the present disclosure;

FIG. 2 shows a second embodiment of a target image according to the present disclosure;

FIG. 3 shows a third embodiment of a target image according to the present disclosure;

FIG. 4 illustrates a flowchart of a test positioning method for a display according to the present disclosure;

FIG. 5 illustrates a schematic diagram of a test positioning device for a display according to the present disclosure; and

FIG. 6 illustrates an example of an autofocus pattern.

### DETAILED DESCRIPTION OF EMBODIMENTS

It should be noted that various components in the figures may be exaggerated for the purpose of illustrative illustration and are not necessarily true to scale. In the accompanying drawings, components that are identical or functionally identical are provided with the same reference numerals in the figures.

In the present disclosure, unless otherwise specified, the words “arranged on”, “arranged above” and “arranged over” do not exclude the existence of intermediates between the two. Furthermore, “arranged on or above” merely indicates the relative positional relationship between the two components, but under certain circumstances, such as when the product direction is reversed, it can be converted to “arranged under or below”, and vice versa.

In the present disclosure, the embodiments are merely intended to illustrate the scheme of the present disclosure and should not be construed as limiting.

In the present disclosure, the quantifiers “a” and “one” do not exclude scenarios with a plurality of elements, unless otherwise specified.

In the present disclosure, the term “connect” may refer to either the two being directly connected or the two being indirectly connected through an intermediate component.

In the present disclosure, the term “configure” refers to the setting of the shape, structure, material, and/or function of a target object to achieve a desired technical effect, and “configure” includes various alternative technical means to achieve this technical effect, these technical means become apparent under the teachings of the present disclosure.

In the present disclosure, the controller may be implemented using software, hardware, firmware, or a combination thereof. The controller may exist independently or also be a part of a component.

It should also be noted herein that in embodiments of the present disclosure, merely a part of the components or assemblies may be shown for the sake of clarity and simplicity, but those ordinary skilled in the art will be able to understand that the required components or assemblies may be added as needed according to specific scenarios in light of the teachings of the present disclosure. Furthermore, features in different embodiments of the present disclosure may be combined with each other unless otherwise indicated. For example, a feature in the second embodiment may be substituted for a corresponding or functionally identical or similar feature in the first embodiment, and the obtained embodiment likewise falls within the scope of the disclosure or the scope of the record of the present application.

It should also be noted that, within the scope of the present disclosure, the terms “the same”, “equal”, “equal to”, etc. do not mean that the two numerical values are absolutely equal, but rather allow for a certain reasonable error, that is to say, the terms also cover “substantially the same”, “substantially equal” and “substantially equal to”. By analogy, in the present disclosure, the terms “perpendicular to”, “parallel to”, etc., which indicate direction, also cover the meaning of “substantially perpendicular to”, “substantially parallel to”.

In the present disclosure, the term “configure” refers to the setting of the shape, structure, material, and/or function of a target object to achieve a desired technical effect, and “configure” includes various alternative technical means to achieve this technical effect, these technical means become apparent under the teachings of the present disclosure.

First, the principle on which the present disclosure is based is explained.

The present disclosure is particularly advantageous when applied to displays using optical shaping devices such as optical waveguides of near-eye displays and the like, because in near-eye displays, optical devices such as Fresnel lenses, pancake lenses, prisms, freeform surfaces, and optical waveguides and the like will perform shaping operations such as magnification on display image, etc., which may cause pixel distortion or brightness unevenness at predetermined positions such as corners and the like. In such cases, if conventional methods using uniformly sized positioning points are used to locate pixels, it is easy to cause recognition failures or significant errors, which in turn can have a negative impact on subsequent corrections and damage the user experience. In the present disclosure, by using second positioning points that are different in size or shape from the first positioning points to locate pixels in special areas such as corners, even if a pixel in one of the four corners is a dead point, and cannot be turned on, or has poor uniformity, due to the area of the bright region being large or the shape being significantly different, the pixels in these areas can still be accurately located.

Furthermore, the present disclosure can accurately determine the homography transformation matrix through the second positioning points, which can further reduce the computational load of recognition; this is because the position of the predetermined position on the display can be accurately determined in advance, and the second positioning points in the predetermined position can also be accurately identified in the captured image, therefore, the homography transformation matrix determined through the correspondence between the two is also highly accurate. After determining the homography transformation matrix, the first positioning points and second positioning points can be transformed according to the determined homography transformation matrix to obtain a mapping point set between the target image and the first captured image. Furthermore, the homography transformation matrix can also be used to correct distortions and rotations in the captured images. This significantly reduces the correction computational load in the subsequent transformation process of the first positioning points and improves the positioning accuracy.

It can be seen that through the present disclosure, the robustness and accuracy of the positioning algorithm in special areas (particularly the four corners) is greatly improved.

The present disclosure will be further explained by means of specific embodiments below.

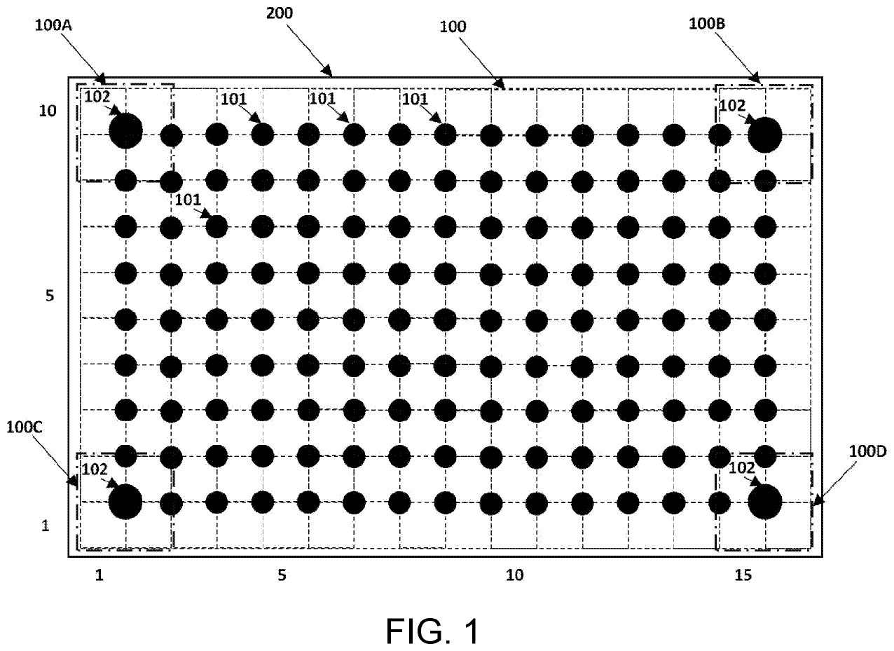

FIG. 1 illustrates a first embodiment of a target image according to the present disclosure.

As shown in FIG. 1, the display 200 is divided into a plurality of square virtual grids, and the virtual grids are only used to characterize segmentations of pixels and are not physically present. In the present embodiment, the display 200 has 16×10 virtual grids, and each virtual grid includes a plurality of pixels, such as 2×2, 8×8, 10×10, 16×16, 256×256, etc. Display 200 may be any type of display. The display 200, for example, may include a computer display, an optical waveguide, a near-eye display, a virtual reality VR display, an augmented reality AR display, a smartwatch display, and a smartphone display, etc.

Furthermore, display 200 also includes a plurality of predetermined positions 100A-100D (see dashed box in FIG. 1). In the present embodiment, the number of predetermined positions 100A-100D is four, which are distributed at the four corners of display 200, and their sizes are as follows: each predetermined position 100A-100D is square with a side length of ⅛th of the side length of the display 200. It should be noted that the present embodiment is merely exemplary, and in other embodiments, the predetermined positions may be more, e.g., 5, 6, 10, etc.; the sizes of the predetermined positions may be other sizes, such as a side length of 1%-30% of the side length of the display 200, e.g., 5%, 10%, 25%, etc. Generally, the predetermined positions include an integer number of pixels, so their specific size can be determined according to the number of pixels. Furthermore, in other embodiments, the predetermined positions may be located in areas of the display other than the corners, for example, they may be located at various positions, such as the center position, slightly left of center, slightly right of center, slightly above center, or slightly below center.

The target image 100 is displayed on the display 200. Specifically, the target image 100 displayed on the display 200 includes a plurality of first positioning points 101 and a plurality of second positioning points 102. Herein, the shapes of the first positioning points 101 and the second positioning points 102 may be different from each other or be shapes other than circles, for example, triangles, squares, rectangles, ellipses, irregular shapes, and n-sided polygons, and n≥5. The first positioning points 101 may include one or more pixels, such as 1, 10, 16, 32, 64, etc. The second positioning points 102 may include a plurality of pixels, for example, 10, 16, 32, 64, etc. The dimensions of the second positioning points 102 are preferably larger than the dimensions of the first positioning points 101, for example, the dimensions of the second positioning points 102 are preferably 1.2 to 10 times or more, preferably 1.5 to 5 times the dimensions of the first positioning points 101. The dimensions of the first positioning points 101 and the second positioning points 102 may, for example, be the radius or diameter, while in other embodiments, the dimensions may further include area, side length, maximum transversal dimension, or maximum longitudinal dimension, etc. For example, if the shapes of the first positioning points 101 are the same as the shapes of the second positioning points 102, and the main difference lies in size, area can be used as the distinguishing metric; if the first positioning points 101 and the second positioning points 102 are circles, the radius can be used as the distinguishing metric; if the first and/or second positioning points 101 and 102 are irregular shapes or n-sided polygons (n is greater than 4), the maximum transversal/longitudinal dimension/side length can be used as the distinguishing metric.

The specific position of the second positioning points 102 in the target image 100 can be predetermined, for example, each second positioning point 102 includes display pixels with corresponding coordinate positions, respectively. For example, the second positioning points 102 in the lower-left corner may include a first pixel array having n pixels, whose coordinates are (x0, y0), (x1, y1), . . . , (xn, yn), respectively. Since the positions of the second positioning points 102 are known, when all the second positioning points 102 are identified in the captured image, the second positioning points can be respectively mapped to corresponding predetermined positions, and thereby to corresponding coordinate positions on the display 200 or the target image 100. Through the coordinate positions of the second positioning points 102 on the target image 100 and their coordinate positions on the captured image, the homography transformation matrix between the target image 100 and the captured image can be obtained. Furthermore, if it is determined that there is distortion or rotation between the second positioning points 102 on the captured image and the second positioning points 102 on the target image, then the captured image can be corrected to remove the distortion or rotation. Its method includes, for example, the following ways: first, capturing a distortion correction image without distortion and identifying the undistorted second positioning points 102 therein; then determining distortion correction coefficients according to the pixel coordinates (e.g., center or barycentric coordinates of the second positioning points 102) of the undistorted second positioning points 102 and the distorted second positioning points 102; next, correcting the target image 100 using the distortion correction coefficients; and displaying the corrected target image by the display 200. For rotation or torsion, the same correction method can be used.

After the homography transformation matrix is determined and optional correction processes are completed, the position data (e.g., coordinates) of the first positioning points 101 and the second positioning points 102 in the target image 100 can be transformed into the position data (e.g., coordinates) of the first positioning points 101 and the second positioning points 102 in the captured image to form a mapping point set between the target image and the first captured image, and the mapping point set may include the mapping point set for all pixels of the first positioning points and second positioning points, and optionally may include the mapping point set for other positions in the image. After the mapping point set is determined, brightness and/or chromaticity extraction may be performed on the subsequently displayed test image for brightness and/or chromaticity correction.

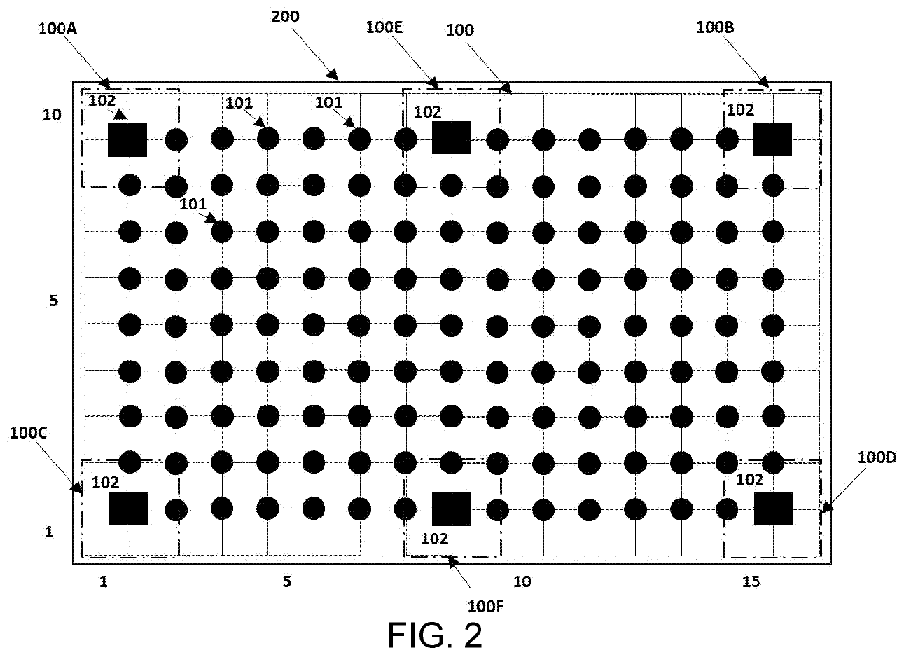

FIG. 2 illustrates a second embodiment of a target image according to the disclosure.

The second embodiment in FIG. 2 is basically the same as the first embodiment in FIG. 1, and the primary difference lies in that in the second embodiment of FIG. 2, the display 200 includes 6 predetermined positions 100A-100F, and the second positioning points 102 at the predetermined positions 100A-100F are squares. That is, compared with the first embodiment in FIG. 1, in the second embodiment in FIG. 2, two predetermined positions 100E and 100F at the center position are added. The predetermined position layout of the second embodiment can more completely cover the border area of the rectangular display 200. Furthermore, adding two second positioning points 102 can more accurately determine the homography transformation matrix, this is because determining the homography transformation matrix requires 4 positioning points, while adding two positioning points can determine a plurality of homography transformation matrices, and then the average of the matrix elements can be taken, or the 4 most accurate points out of the 6 can be selected to determine the homography transformation matrix. Furthermore, when the second positioning points 102 are square pixel blocks, they can be distinguished from the first positioning points 101 during detection by detecting their side length, area, or maximum transversal/longitudinal width. Furthermore, compared with a circle, a square has a larger area when the width is the same, thereby covering more surrounding pixels, which ensures reliable positioning even if these pixels exhibit defects such as dead pixels, chromaticity differences, or brightness variations.

The size of the second positioning points 102 can be determined, for example, through statistical data to determine. Such statistical data may include, for example, the probability distribution of defective pixels in various display areas in historical display test data, then by setting the second positioning points 102 of appropriate sizes to cover the area with the highest probability of defective pixels. Similarly, the area with the greatest chromaticity difference can also be covered by the second positioning points 102 using this method.

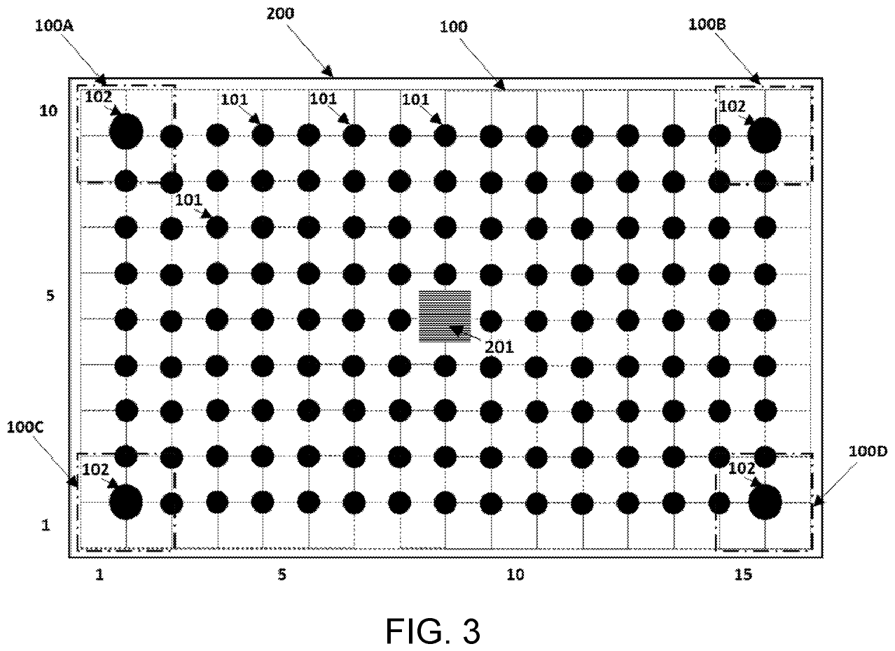

FIG. 3 illustrates a third embodiment of a target image according to the present disclosure.

The third embodiment in FIG. 3 is basically the same as the second embodiment in FIG. 2, and the primary difference lies in that in the third embodiment of FIG. 3, the target image 100 also includes an autofocus pattern 201. The autofocus pattern 201 may be arranged in any determined area on the target image 100, preferably at the center of the target image 100.

Autofocus is important for precise image positioning for the following reasons. In practical applications, the virtual image distance of modules in the same batch may not be completely consistent due to minor differences in the manufacturing process. This makes it difficult for imaging devices (e.g., cameras) to accurately complete positioning tasks without adjusting the focus ring, resulting in blurry images that seriously affect the subsequent operation of positioning algorithms. Therefore, the autofocus function is particularly critical, it dynamically adjusts the focus ring according to actual imaging situations, ensuring that clear images can be obtained regardless of changes in the virtual image distance of the module, which provides a reliable data foundation for positioning algorithms and guarantees the accuracy and efficiency of positioning work.

The autofocus pattern 201 may be, for example, a pattern including lines, which can be measured for image clarity using the line pair MTF (modulation transfer function) method to determine whether the focus is correct. A line pair refers to a pair of alternating black and white lines with equal width, and the number of line pairs that can be distinguished per millimeter (lp/mm) is a unit of measurement for resolution, and the more line pairs that can be distinguished, the higher the resolution and the higher the potential clarity of the image. The autofocus process, for example, may include: using actuators such as robotic arms to simultaneously measure the clarity of the autofocus pattern in the captured image while moving the camera; when the clarity is greater than or equal to a threshold, it is considered that the focus is correct, otherwise continue to move the camera. The movement, for example, may include rotating the camera (e.g., around a horizontal axis or a vertical axis or any other axis), and adjusting the distance between the camera and the display, etc.

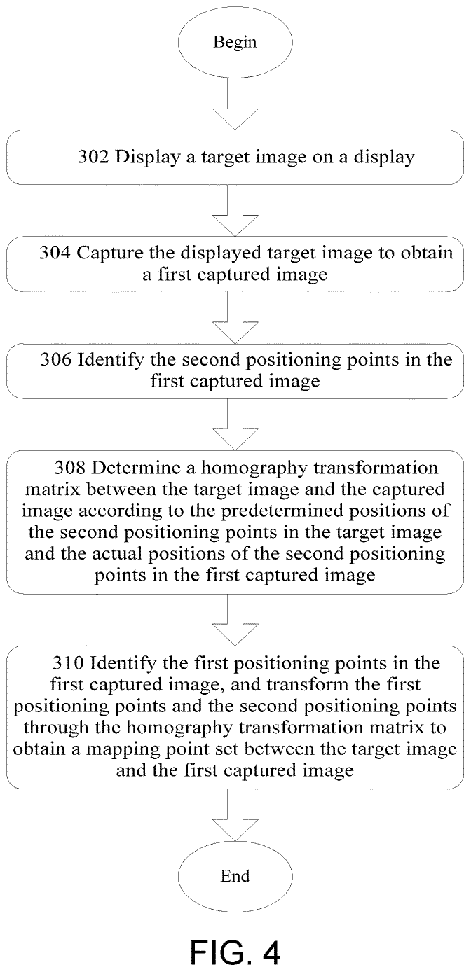

FIG. 4 illustrates a flowchart of a test positioning method for a display according to the present disclosure. The autofocus pattern 201, for example, may include various forms of lines, such as transversal line groups, longitudinal line groups, oblique line groups, and combinations of the above lines.

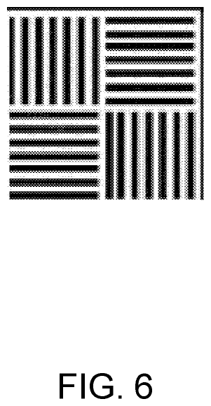

An example of the combination of lines includes:
(1) A square or rectangular pattern including one transversal line group+three longitudinal line groups;
(2) A square or rectangular pattern including two transversal line groups+two longitudinal line groups, and for the specific pattern, reference is made to FIG. 6, and it can be seen in FIG. 6 that the transversal line groups and longitudinal line groups are spaced apart from each other, and the advantage of doing this is that the transversal and longitudinal lines can be referenced by each other, ensuring clarity in multiple directions and improving the focusing effect.
(3) A square or rectangular pattern including three transversal line groups and one longitudinal line group.

The transversal line groups refer to lines oriented parallel to the transversal dimension (e.g., length or width) of the display, longitudinal line groups refer to lines oriented perpendicular to the transversal dimension of the display, and oblique line groups refer to lines forming angles between 0° and 90° relative to the transversal dimension of the display.

In step 302, a target image is displayed on the display, and the target image includes a plurality of first positioning points and a plurality of second positioning points, and the shapes and/or dimensions of the second positioning points are different from the shapes and/or dimensions of the first positioning points, and the second positioning points are located at predetermined positions of the target image. The positions of the first and second positioning points on the target image are known in advance, for example, the coordinates of each pixel they cover on the target image can be determined. The display may include various types of displays, for example, optical waveguides, computer displays, near-eye displays, virtual reality VR displays, augmented reality AR displays, smartwatch displays, and smartphone displays. The process of displaying an image on the display can be achieved, for example, by the driving device of the display reading image data, which, for example, include the brightness and chromaticity of each pixel, and then the display turns on the corresponding pixels according to this image data.

In step 304, the displayed target image is captured to obtain the first captured image. For example, the displayed target image can be captured by a camera. For example, the camera may include a digital camera, webcam, SLR camera, etc. The camera is preferably facing the display to reduce image distortion or rotation caused by positional deviation. For example, the first captured image is in various formats, such as JPEG, BMP, PNG, AI, TIF, RAW, etc. The image format includes the brightness and/or chromaticity information of the corresponding pixels generated by the camera sensor.

In step 306, second positioning points are identified in the first captured image. This identification process, for example, may be achieved through image recognition process. For example, first, all circular contours are extracted in the target image information, and the centers of all circular contours are fitted to traverse all circular contours, and large circular spots and small circular spots are found according to an area threshold, and the large circular spots are the second positioning points, and the small circular spots are the first positioning points. Herein, it is possible to additionally check whether the identified second positioning points match their actual number (e.g., a natural number N, and N=4, 5, 6 . . . ). If so, identification is complete. If not, identification fails. Generally speaking, after identification failure, it may be necessary to check whether the displayed image is obscured, and identification parameters can be adjusted, or intervened in manually, such as by performing manual annotation, etc.

In step 308, the homography transformation matrix between the target image and the captured image is determined according to the predetermined positions of the second positioning points in the target image and the actual positions of the second positioning points in the first captured image. For example, the homography transformation matrix is determined using the center of the identified large spots as key control points. Optionally, efficient and precise transformation operations can be applied to images with distortion and rotation angles, so that the original image can be adjusted to a horizontal regular image similar to a target template, facilitating subsequent processing. The process for determining the homography transformation matrix is described below.

First, corresponding points are determined. This requires finding at least four sets of corresponding points on two planes (i.e., the target image and the first captured image). These corresponding points can be feature points in the image, such as corners or edge points, etc., or the positions of known markers. In the present disclosure, these four feature points are at least four second positioning points herein. For example, in image registration, feature extraction algorithms (e.g., SIFT, SURF, etc.) are used to find feature points in both images, and then feature matching algorithms are used to determine which points correspond.

Then, a system of equations is constructed. The homography transformation matrix His set to be a 3×3 matrix:

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ]$$

For a pair of corresponding points (x, y) and (x′, y′), they satisfy the homography transformation relationship:

$$[ \begin{matrix}{x}^{′} \\ {y}^{′} \\ 1\end{matrix} ] = H [ \begin{matrix}x \\ y \\ 1\end{matrix} ]$$

The above equation is expanded to obtain two equations:

$$\{ \begin{matrix}{x}^{′} = \frac{{h}_{11} x + {h}_{12} y + {h}_{13}}{{h}_{31} x + {h}_{32} y + {h}_{33}} \\ {y}^{′} = \frac{{h}_{21} x + {h}_{22} y + {h}_{23}}{{h}_{31} x + {h}_{32} y + {h}_{33}}\end{matrix}$$

These are arranged into the form of linear equations:

$$\{ \begin{matrix}{x}^{′} ( {h}_{31} x + {h}_{32} y + {h}_{33} ) = {h}_{11} x + {h}_{12} y + {h}_{13} \\ {y}^{′} ( {h}_{31} x + {h}_{32} y + {h}_{33} ) = {h}_{21} x + {h}_{22} y + {h}_{23}\end{matrix}$$

Each pair of corresponding points provides two such equations, since there are 9 elements but there is a scale uncertainty (i.e., H and kH represent the same transformation, and k is any non-zero constant), only 8 independent equations need to be determined, therefore, at least 4 groups of corresponding points are required.

After constructing an equation system with at least 4 groups of corresponding points, a plurality of methods can be used to solve the homography transformation matrix. Common methods include direct linear transformation (DLT), least squares method, etc.

The obtained homography transformation matrix H may have scale uncertainty and needs to be normalized, typically, h₃₃ is set to 1, and then other elements are divided by h₃₃ to obtain a definite homography transformation matrix:

$$H = [ \begin{matrix}{h}_{11} & {h}_{12} & {h}_{13} \\ {h}_{21} & {h}_{22} & {h}_{23} \\ {h}_{31} & {h}_{32} & 1\end{matrix} ]$$

In step 310, the first positioning points in the first captured image are identified, and the first positioning points and the second positioning points are then transformed using the homography transformation matrix to obtain a mapping point set between the target image and the first captured image. The transformation process is to multiply the coordinates of the first positioning points and the second positioning points or their respective pixels in the target image by the determined homography matrix to obtain the coordinates of the corresponding pixels in the first captured image, and the coordinates are then stored in pairs.

Next, a test image can be displayed on a display and captured to generate a second captured image. According to the mapping point set, the brightness and/or chromaticity of corresponding pixels on the test image can be determined to facilitate subsequent brightness and/or chromaticity correction or adjustment.

Optionally, the point set is sorted according to a Z-shaped distribution based on the coordinate relationships of the mapping point set. The sorted point set is interpolated and supplemented, i.e., missing pixels (bright points on the target image but not bright points on the captured image) are supplemented through interpolation according to geometric coordinate relationships. Empty pixels (not bright points on the target image) are interpolated and supplemented to the point set after the first interpolation supplement to obtain a dual-channel image including xy coordinate information of the resolution size of the target image. Interpolation methods, for example, may include: Lagrange interpolation, Newton interpolation, piecewise linear interpolation, cubic spline interpolation, bilinear interpolation, etc. The purpose of the interpolation is to complete the pixels that should be turned on in the target image and the captured image, so that a complete mapping point set is obtained.

Herein, in addition to sorting rule based on the Z-shaped, sorting based on coordinate mapping and sorting based on feature matching can also be used. These three sorting methods are described below:

(A) Sorting based on Z-shaped: Z-shaped sorting is a way of arranging data along a specific Z-shaped path. Its specific implementation, for example, includes sorting by matrix elements or sorting by number of rows in a string. Taking the sorting by matrix elements as an example, if the vertical axis of the element is even and the horizontal axis is 0 or the matrix side length is Size-1, then the traversal path is horizontally shifted one grid to the right. If the horizontal axis of the element is even and the vertical axis is 0 or Size-1, then the traversal path is vertically moved down one grid. In addition to the above situations, if the sum of the horizontal and vertical coordinates is even, then the traversal path is moved one grid to the upper right corner; if it is an odd number, then the traversal path is moved one grid to the bottom left corner.

(B) Sorting based on feature matching: in pixel positioning method based on feature, e.g., the SIFT feature matching algorithm is that, feature descriptors are calculated by extracting feature points from the image, and then matching and positioning are performed according to the similarity of feature descriptors, and the mapping point set is determined based on the similarity and spatial relationship of features.

(C) Sorting based on coordinate mapping: in some pixel positioning methods based on geometric transformation, for example, mapping world coordinates to pixel coordinates through camera calibration, the coordinate relationship of corresponding points is determined according to mathematical projection transformation principles and geometric relationships, and the transformation matrix is calculated.

Furthermore, the mapping point set can also be sorted according to methods such as deep learning, etc.

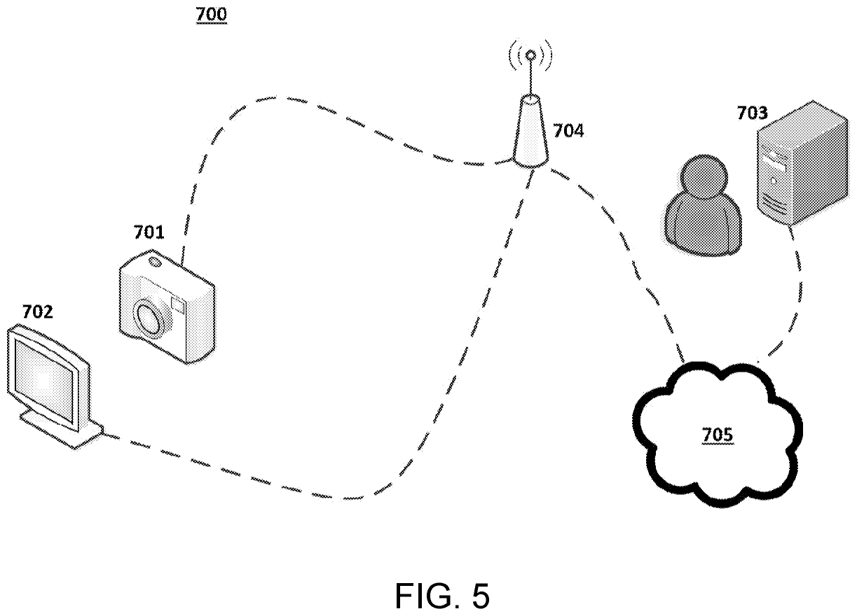

FIG. 5 illustrates a schematic diagram of a test positioning device for a display according to the present disclosure.

As shown in FIG. 5, the test positioning device 700 for a display according to the present disclosure includes a camera 701 and a controller 703. Furthermore, the test positioning device 700 may optionally include a router 704 and a network 705, for example, the Internet and an intranet. The various components of the test positioning device 700 are described below, respectively.
The camera 701, configured to capture pixel images of display 702, and display 702 includes a plurality of pixels and is divided into a plurality of sub-areas. The display 702 covers various forms and types of displays, such as monochrome displays, color displays, light-emitting panels, printer print heads, micro-LED displays, etc. The camera 701 may be a digital camera, a camcorder, a brightness sensor, and a brightness meter, etc.
The controller 703, which may be in various forms such as a central processing unit (CPU), a microcontroller (MCU), an application-specific integrated circuit (ASIC), a field-programmable gate array (FPGA), and a personal computer, etc. Herein, the controller 703 is shown as a computer. The controller 703 is configured, for example, through software or hardware programming, to determine one or more crosstalk factors according to the captured pixel image, for example, the controller 703 is configured according to the method of the present disclosure. Taking a computer executable method as an example, the executable method may exist in the form of program instructions and be executed in a processor to perform the method according to the present disclosure. For example, a test positioning method for a display may be executed on the controller 703, which includes the following steps: first, sending signals to a display to display a target image, and the target image includes a plurality of first positioning points and a plurality of second positioning points, and the shapes and/or dimensions of the second positioning points are different from the shapes and/or dimensions of the first positioning points, and the second positioning points are located at predetermined positions of the target image; then, sending signals to a camera to capture the displayed target image to obtain a first captured image; then, identifying the second positioning points in the first captured image; then, determining a homography transformation matrix between the target image and the captured image according to the predetermined positions of the second positioning points in the target image and the actual positions of the second positioning points in the first captured image; and identifying the first positioning points in the first captured image, and transforming the first positioning points and the second positioning points through the homography transformation matrix to obtain a mapping point set between the target image and the first captured image. Furthermore, the controller 703 may also perform a method for providing a target image, which includes the following steps: first, generating image signals for displaying a target image, and the target image includes a plurality of first positioning points and a plurality of second positioning points, and the shapes and/or dimensions of the second positioning points are different from the shapes and/or dimensions of the first positioning points, and the second positioning points are located at predetermined positions of the target image; then, displaying the image signal.
An optional router 704, configured to connect camera 701 to network 705. Alternatively, in another application scenario, router 704 is configured to achieve communication between camera 701 and controller 703, for example, both camera 701 and controller 703 are connected to router 704, therefore, they can communicate directly through wired or wireless means. Router 704 may be, for example, a wired router or a Wi-Fi router.
An optional network 705, configured to achieve communication between controller 703 and router 704, thereby achieving communication between controller 703 and camera 701. Network 705 may be, for example, the Internet, an intranet, etc. Display 702 may optionally also be connected to network 705 or router 704, so that controller 703 can send control signals through network 705 or router 704 to turn on corresponding pixels on display 702, thereby achieving remote test positioning. Herein, display 702 is connected to router 704. Of course, display 702 may also be connected to a controller located on site for direct control.

Furthermore, display 702 may include micro-LED chips. Display 702 may include various types of displays, for example, optical waveguides, computer displays, near-eye displays, virtual reality (VR) displays, augmented reality (AR) displays, smartwatch displays, and smartphone displays.

Taking micro-LED chips as an example, the display 702 is explained below.

The panel of display 702 may include micro-LED chips. Micro light-emitting diode (Micro-LED) is a new type of LED structure obtained by thin-filming, miniaturizing, and arraying the original LED structure, which integrates the arrayed micro level micro-LEDs on an active addressing drive panel to achieve the lighting and individual control of the micro-LEDs, thereby outputting the desired display image. The core structure of the micro-LED is a light-emitting mesa, which includes a PN junction diode composed of direct-bandgap semiconductor material. When the upper and lower electrodes apply a forward bias voltage to the micro-LED to allow current to pass through, electrons and holes recombine in the active region, and meanwhile emit monochromatic light photons.

The micro-LED chip may include, for example: a light-emitting mesa, an insulating layer, a drive circuit, a first electrode, a passivation layer, a top transparent conductive layer, and a second electrode. The insulating layer is used to accommodate the light-emitting mesa and through-hole contact portions, for example, it is made of insulating materials such as silicon oxide or silicon nitride, etc. The drive circuit is used to drive the light-emitting diode and its surface is provided with a metal layer, the drive circuit is provided with a plurality of through-hole contact portions on it, and the through-hole contact portions are electrically connected with the metal layer, and the micro-LED array area is bonded on the drive circuit through a bottom conductive bonding layer, and the drive circuit also has a wiring stacked layer below the metal layer, which leads out the first electrode. The first electrode, for example, is an anode that electrically connects the light-emitting mesa to the drive circuit. The passivation layer covers at least a part of the side surface of the light-emitting mesa to protect the light-emitting mesa from metal diffusion from layers such as the reflective mirror layer, etc. The top transparent conductive layer is located on the surface of the passivation layer and is in electrical contact with the second epitaxial layer. The second electrode is located on the surface of the transparent conductive layer, and the second electrode, for example, is a cathode.

The light-emitting mesa includes a first type epitaxial layer, a second type epitaxial layer, and a light-emitting layer located between the two. The first type of epitaxial layer is electrically connected with the ohmic contact layer. The second type of epitaxial layer is electrically connected to the top conductive layer. In some embodiments of the present disclosure, the light-emitting mesa of each micro-LED in the micro-LED array may be a micrometer-level light-emitting mesa. In some embodiments of the present disclosure, the micrometer-level light-emitting mesa may include, from bottom to top, a first type epitaxial layer, a light-emitting layer, and a second type epitaxial layer. That is to say, in the three-layer structure, the first type epitaxial layer is closest to the drive backplane; the light-emitting layer is located above the first type epitaxial layer and further away from the drive backplane; and the second type epitaxial layer is located above the light-emitting layer and furthest away from the drive backplane. In one embodiment of the present disclosure, the light-emitting layer is formed by multiple stacked quantum-well layers, particularly superlattice-stacked quantum-well layers. Preferably, the superlattice-stacked quantum-well layers include multiple pairs of quantum-well layers stacked with quantum barrier layers. In one embodiment of the present disclosure, the first type epitaxial layer is a semiconductor material having a first conductivity type and includes a plurality of semiconductor layers. The primary base material of the first type epitaxial layer may be, but is not limited to, materials such as Ga, N, As, P, In, or Al, etc. Furthermore, the first type epitaxial layer may include, from top to bottom, but is not limited to, a waveguide layer, a confinement layer, a transition layer, and a window layer; furthermore, an ohmic contact layer may be formed beneath the window layer. In one embodiment of the present disclosure, the second type epitaxial layer is a semiconductor material having a second conductivity type and includes a plurality of semiconductor layers. The primary base material of the second type epitaxial layer may be, but is not limited to, materials such as Ga, N, As, P, In, or Al, etc. Furthermore, the first type epitaxial layer may include, from top to bottom, but is not limited to, a confinement layer and a waveguide layer; furthermore, in one embodiment of the present disclosure, an ohmic contact layer may be formed on the confinement layer. In one embodiment, the first conductivity type is different from the second conductivity type.

In one embodiment, the first type epitaxial layer is an N-type GaN layer or an N-type AlGaN layer, and the second type epitaxial layer is a P-type GaN layer or a P-type AlGaN layer, that is, the material of the second type epitaxial layer may be a material layer of the second conductivity type including at least two or more elements of Ga, N, As, Al, In, and P, and the material of the first type epitaxial layer may be a material layer of the first conductivity type including at least two or more elements of Ga, N, As, Al, In, and P. In one embodiment, the light-emitting layer includes a multi-quantum-well layer and an electron barrier layer, and the multi-quantum-well layer is an InGaN/GaN multi-quantum-well layer, or an InGaN/AlGaN multi-quantum-well layer, or an InGaAs/AlGaAs multi-quantum-well layer. In another embodiment, the first type epitaxial layer may also be a P-type GaN layer or a P-type AlGaN layer, and the second type epitaxial layer is an N-type GaN layer or an N-type AlGaN layer.

In some embodiments, the light-emitting layer includes at least one quantum well layer. The thickness of the quantum well layer is between 20 nm and 40 nm, for example, the thickness is 30 nm. In some embodiments of the present disclosure, the material of the quantum well layer is GaInP/(AlₓGa₁₋ₓ)_{y}In_{1-y}P, and the range of x is 0.5 to 0.9, and the range of y is 0.3 to 0.5. For example, x is 0.8 and y is 0.5. In one embodiment of the present disclosure, the relationship between x and y is that x is 1 to 2 times y. In one embodiment of the present disclosure, the light-emitting layer is a multi-quantum well (MQW).

The size of each micro-LED chip does not exceed 1 centimeter, preferably not exceeding 20 micrometers. The micro-LED structures are formed in the form of an array in the micro-LED chip, with resolutions such as 720*480, 640*480, 1920*1080, 1280*720, 2K, or 4K. The diameters of the micro-LED structures are in the nanometer-level, for example, 20 nm to 100 nm.

In some embodiments of the present disclosure, the micro-LED array may include a single-layer micro-LED structure. In some embodiments of the present disclosure, the micro-LED array may include a multi-layer vertically stacked micro-LED structure.

In some embodiments of the present disclosure, the micro-LED array may include blue micro-LEDs. In some embodiments of the present disclosure, the pitch of the micro-LED array, i.e., the minimum center-to-center distance between micro-LEDs may range from approximately 2 micrometers to approximately 50 micrometers. In some embodiments, the number of pixels on a micro-LED chip may range from thousands to millions.

In one embodiment of the present disclosure, the drive backplane may be electrically connected with each micro-LED in the micro-LED array through individual metal interconnections. In some embodiments, each micro-LED may be individually electrically controlled by the drive backplane. In some embodiments, the drive backplane may be electrically connected with the electrodes of the micro-LED chips through metal interconnections. In some embodiments, a dielectric layer may be formed in the gaps between the micro-LEDs. In some embodiments, the dielectric layer may also be formed in the gaps between the interconnections.

The micro-LED chip includes a plurality of micro-LED arrays, and each micro-LED array includes a plurality of micro-LEDs. The drive method of the micro-LEDs is, for example, a passive matrix (PM) drive, and the cathodes of all micro-LEDs of each array are connected together to a cathode line NL, while micro-LEDs of the same number of each array are connected to corresponding anode lines PL, respectively. Thus, the on/off and brightness of each LED can be individually controlled by controlling the signal on the corresponding cathode and anode.

Although some embodiments of the present disclosure have been described in the present application, those skilled in the art will appreciate that these embodiments are merely illustrated as examples. Numerous variation schemes, alternative schemes, and improvement schemes may be conceived by those skilled in the art in light of the teachings of the present disclosure without departing from the scope of the present disclosure. The appended claims are intended to define the scope of the present disclosure and thus encompass methods and structures within the scope of these claims themselves and their equivalent variations.

What is claimed is:

1. A test positioning method for a display, comprising:
displaying a target image on the display, wherein the target image comprises a plurality of first positioning points and a plurality of second positioning points, and the shapes and/or dimensions of the second positioning points are different from the shapes and/or dimensions of the first positioning points, wherein the second positioning points are located at predetermined positions of the target image;
capturing the displayed target image to obtain a first captured image;
identifying the second positioning points in the first captured image;
determining a homography transformation matrix between the target image and the first captured image according to the predetermined positions of the second positioning points in the target image and actual positions of the second positioning points in the first captured image; and
identifying the first positioning points in the first captured image, and transforming the first positioning points and the second positioning points through the homography transformation matrix to obtain a mapping point set between the target image and the first captured image.

2. The method according to claim 1, further comprising:
displaying a test image on the display;
capturing the displayed test image to obtain a second captured image; and
obtaining brightness information and/or chromaticity information of the test image according to the second captured image through the mapping point set.

3. The method according to claim 1, wherein the target image is a rectangle, and the predetermined positions comprise four corners of the rectangle, wherein each corner comprises a square area with a side length of 1% to 30% of the side length of the rectangle.

4. The method according to claim 1, wherein the shapes of the second positioning points are different from the shapes of the first positioning points, the shapes of first positioning points are circles, and the shapes of the second positioning points are selected from triangles, squares, rectangles, ellipses, or n-sided polygons, wherein n≥5.

5. The method according to claim 1, wherein the dimensions of the second positioning points are different from the dimensions of the first positioning points, and the dimensions of the second positioning points are 1.5 to 5 times the dimensions of the first positioning points.

6. The method according to claim 5, wherein the dimensions comprise: area, diameter, radius, side length, maximum transversal dimension, or maximum longitudinal dimension.

7. The method according to claim 1, wherein the plurality of second positioning points comprise at least four second positioning points.

8. The method according to claim 1, wherein after determining the homography transformation matrix, the method further comprises:
correcting the first captured image to suppress distortion and/or rotation in the first captured image.

9. The method according to claim 8 wherein correcting the first captured image to suppress distortion and/or rotation in the first captured image comprises the following steps:
capturing a distortion correction image without distortion;
identifying the second positioning points without distortion in the distortion correction image;
identifying the second positioning points with distortion in the first captured image;
determining distortion correction coefficients according to pixel coordinates of the second positioning points without distortion and the second positioning points with distortion;
correcting the first captured image using the distortion correction coefficients; and
displaying the corrected first captured image on the display.

10. The method according to claim 1, further comprising:
sorting the mapping point set according to a sorting rule based on the coordinates of the mapping point set; and
interpolating and supplementing the sorted mapping point set to supplement missing pixels in the first captured image to the mapping point set, wherein the missing pixels are pixels that are bright on the target image but not bright on the first captured image.

11. The method according to claim 1, further comprising:
sorting the mapping point set according to a sorting rule based on the coordinates of the mapping point set; and
interpolating and supplementing the sorted mapping point set to supplement empty pixels to the mapping point set, wherein the empty pixels are pixels that should be bright but are not bright on the target image.

12. The method according to claim 10, wherein the sorting rule comprises at least one of the following:
sorting based on Z-shape, sorting based on coordinate mapping, or sorting based on feature matching.

13. The method according to claim 1, wherein the dimensions of the first positioning points are different from the dimensions of the second positioning points, wherein the dimensions of the first positioning points are less than a first threshold and the dimensions of the second positioning points are greater than a second threshold, wherein:
identifying the first positioning points in the first captured image comprises:
extracting the first graphic with a dimension less than the first threshold from the target image through image recognition; and
identifying the first graphic with a dimension less than the first threshold as the first positioning points; and
identifying the second positioning points in the first captured image comprises:
extracting a second graphic with a dimension greater than the second threshold from the target image through image recognition; and
identifying the second graphic as the second positioning points.

14. The method according to claim 1, wherein the first positioning points have a first shape and the second positioning points have a second shape, and the first shape is different from the second shape, wherein:
identifying the first positioning points in the first captured image comprises:
extracting a first graphic having the first shape in the target image through image recognition; and
identifying the first graphic as the first positioning points; and
identifying the second positioning points in the first captured image comprises:
extracting a second graphic having the second shape in the target image through image recognition;
identifying the second graphic as the second positioning points; and
determining whether the number of second positioning points equals N.

15. The method according to claim 13, wherein the number of second positioning points is N, and N is a natural number, wherein identifying the second positioning points in the first captured image further comprises:
determining whether the number of second positioning points equals N; and
if so, ending the identification; otherwise, the identification fails.

16. The method according to claim 1, further comprising:
fitting the centers of the second positioning points in the first captured image; and
using the centers as key control points to determine the homography transformation matrix.

17. A test positioning device for a display, comprising:
a camera configured to capture a displayed target image to obtain a first captured image, and capture a test image displayed on the display to obtain a second captured image; and
a controller configured to perform:
transmitting image signals to the display to display a target image on the display, wherein the target image comprises a plurality of first positioning points and a plurality of second positioning points, wherein the shapes and/or dimensions of the second positioning points are different from the shapes and/or dimensions of the first positioning points, wherein the second positioning points are located at predetermined positions of the target image;
identifying the second positioning points in the first captured image;
determining a homography transformation matrix between the target image and the first captured image according to the predetermined positions of the second positioning points in the target image and actual positions of the second positioning points in the first captured image; and
identifying the second positioning points in the first captured image, and transforming the first positioning points and the second positioning points through the homography transformation matrix to obtain a mapping point set between the target image and the first captured image; and
obtaining brightness information and/or chromaticity information of the test image according to the second captured image through the mapping point set.

18. The test positioning device according to claim 17, wherein the target image further comprises an autofocus graphic for autofocusing between the camera and the display.

19. A computer-readable storage medium storing a computer program thereon, and the computer program performs the method according to claim 1 when executed by a processor.

20. A target image, comprising:
a plurality of first positioning points and a plurality of second positioning points, wherein the shapes and/or dimensions of the second positioning points are different from the shapes and/or dimensions of the first positioning points, wherein the second positioning points are located at predetermined positions of the target image.
